(19) United States
(12) Patent Application Publication
(10) Pub. No.: US 2018/0086924 A1
(43) Pub. Date: Mar. 29, 2018

(54) Composite Article and Method of Forming a Composite Article

(71) Applicant: Tyco Electronics Corporation, Berwyn, PA (US)

(72) Inventors: Megan Hoarfrost Beers, Belmont, CA (US); Jialing Wang, Mountain View, CA (US); Quentin F. Polosky, Santa Clara, CA (US); Jaydip Das, Cupertino, CA (US); Ting Gao, Palo Alto, CA (US); Vishrut Vipul Mehta, Santa Clara, CA (US)

(21) Appl. No.: 15/275,085

(22) Filed: Sep. 23, 2016

(51) Int. Cl. C09D 5/24; B29C 67/00; B33Y 70/00; B33Y 80/00; C09D 109/06; C09D 177/00; H01B 1/20

(52) U.S. Cl. CPC C09D 5/24; B29C 67/0055; B29C 67/0081; B33Y 70/00; B29K 2101/12; C09D 109/06; C09D 177/00; H01B 1/20; B33Y 80/00

(57) ABSTRACT

A method of forming a composite article, wherein the method includes providing a composite formulation, the composite formulation including a polymer matrix and at least one additive distributed in the polymer matrix at a concentration of between 10% and 50%, by volume, the at least one additive having a molar percentage of carbon that is equal to or less than 90%, feeding the composite formulation to a printing head of an additive manufacturing device, heating the composite formulation to form a heated composite formulation, extruding the heated composite formulation through a nozzle in the printing head, and depositing the heated composite formulation onto a platform to form the composite article. Also provided is a composite article produced from a composite formulation having at least one additive distributed in a polymer matrix.

### FIELD OF THE INVENTION

The present invention is directed to a composite article and a method of forming a composite article. More particularly, the present invention is directed to a conductive composite article and a method of forming a conductive composite article.

### BACKGROUND OF THE INVENTION

Electrically conductive metal-plastic composite materials are useful in a variety of components. One class of conductive composite generally contains carbon-based conductive filler particles, such as carbon black or graphite, although these materials are not conductive enough for many applications. A more conductive class of composite materials generally include metal particles, such as copper, which are used to produce relatively good electrically conductive composite formulations. However, such materials are not capable of use in certain applications, and/or they are not environmentally-stable when exposed to different extreme conditions required for various electronic and automotive product applications.

In addition, current composite materials belonging to the latter class are usually not capable of use in additive manufacturing applications, such as three-dimensional printing. Specifically, in many instances, the metal particles clog the printing nozzle, interrupting and/or halting the printing process, and prohibiting continuous and/or efficient printing. For example, while tin is sometimes used as a conductive filler or a component of the conductive filler package in the conductive composites, it may separate out at the operating temperatures of the additive manufacturing process and clog the nozzle.

Other metal particles suffer from similar drawbacks, while adjusting the concentration and/or composition of the metal particles may affect the properties of the composite. In particular, removing the tin and/or decreasing the concentration of metal particles may increase resistivity or decrease conductivity, both of which decrease the performance of the composite. Additionally, using more conductive and environmentally stable materials, such as silver, is often expensive and includes operational complexities.

A composite formulation, a composite article, and a method of forming a composite article that show one or more improvements in comparison to the prior art would be desirable in the art.

### BRIEF DESCRIPTION OF THE INVENTION

In an embodiment, a method of forming a composite article includes providing a composite formulation, the composite formulation including a polymer matrix and at least one additive distributed in the polymer matrix at a concentration of between 10% and 50%, by volume, feeding the composite formulation to a printing head of an additive manufacturing device, heating the composite formulation to form a heated composite formulation, extruding the heated composite formulation through a nozzle in the printing head, and depositing the heated composite formulation onto a platform to form the composite article. The depositing of the heated composite formulation to form the composite article includes forming an additive manufacturing structure within the composite article. In this embodiment, the at least one additive has a molar percentage of carbon that is equal to or less than 90%.

In another embodiment, a method of forming a composite article includes providing a composite formulation, the composite formulation including a thermoplastic and at least one additive distributed in the thermoplastic at a concentration of between 10% and 50%, by volume, the at least one additive comprising a filler selected from the group consisting of a metal, a metalloid, a semimetal, a ceramic, and combinations thereof, feeding the composite formulation to a printing head of an additive manufacturing device, heating the composite formulation to form a heated composite formulation, extruding the heated composite formulation through a nozzle in the printing head, and depositing the heated composite formulation onto a platform to form the composite article. The depositing of the heated composite formulation to form the composite article includes forming an additive manufacturing structure within the composite article. In this embodiment, the at least one additive also has a molar percentage of carbon that is equal to or less than 90% and the composite article has anisotropic conductivity.

In still another embodiment, a composite article produced from a composite formulation having at least one additive distributed in a polymer matrix includes the polymer matrix and the at least one additive, the at least one additive including a filler at a concentration of between 10% and 50%, by volume. In this embodiment, the filler has a molar percentage of carbon that is equal to or less than 90% and comprises at least one of a metal, a metalloid, a semimetal, and a ceramic. The composite article has an additive manufacturing structure and an electrical resistivity that is 1×10⁻² to 1×10⁻⁵ ohm-cm.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a process view of a method of forming a composite article, according to an embodiment of the disclosure.

FIG. 2 is a schematic view of a composite formulation having additives distributed in a polymer matrix, according to an embodiment of the disclosure.

FIG. 3 shows a graphical representation of resistivity data for a composite formulation including copper/tin fillers in a nylon resin, according to an embodiment of the disclosure.

FIG. 4 shows a graphical representation of resistivity data for a composite formulation including copper/tin fillers in an ABS resin, according to an embodiment of the disclosure.

FIG. 5 shows a graphical representation of bulk resistivity over time for a composite formulation including copper/tin fillers in a PVDF resin and in an HDPE resin, according to an embodiment of the disclosure.

FIG. 6 shows a graphical representation of resistivity data for a composite formulation including copper/tin fillers and zinc stearate in a nylon resin, according to an embodiment of the disclosure.

FIG. 7 shows a graphical representation of contact resistance data for a composite formulation including copper/tin fillers and zinc stearate in a nylon resin, according to an embodiment of the disclosure.

FIG. 8 is a perspective view of a composite article, according to an embodiment of the disclosure.

FIG. 9 is a perspective view of a composite article, according to another embodiment of the disclosure.

FIG. 10 shows a graphical representation of resistance of a composite article in the X, Y, and Z direction, as a function of force, according to an embodiment of the disclosure.

FIG. 11 shows a graphical representation of resistance of a composite article in the X, Y, and Z direction, as a function of force, according to an embodiment of the disclosure.

Wherever possible, the same reference numbers will be used throughout the drawings to represent the same parts.

### DETAILED DESCRIPTION OF THE INVENTION

Provided are a composite formulation, a composite article, and a method of forming a composite article. Embodiments of the present disclosure, for example, in comparison to concepts failing to include one or more of the features disclosed herein, provide a composite formulation for use in additive manufacturing, provide a composite formulation for use in three-dimensional (3D) printing, provide a conductive composite formulation for use in 3D printing, increase efficiency of 3D printing with a conductive composite formulation, decrease or eliminate clogging of printing nozzles in 3D printing of a conductive composite formulation, decrease or eliminate separation of metal particles during processing, increase efficiency of composite article formation, facilitate formation of composite articles through 3D printing of conductive composite formulations, increase conductivity of composite articles through 3D printing of conductive composite formulations, provide anisotropic 3D printed composite articles, or a combination thereof.

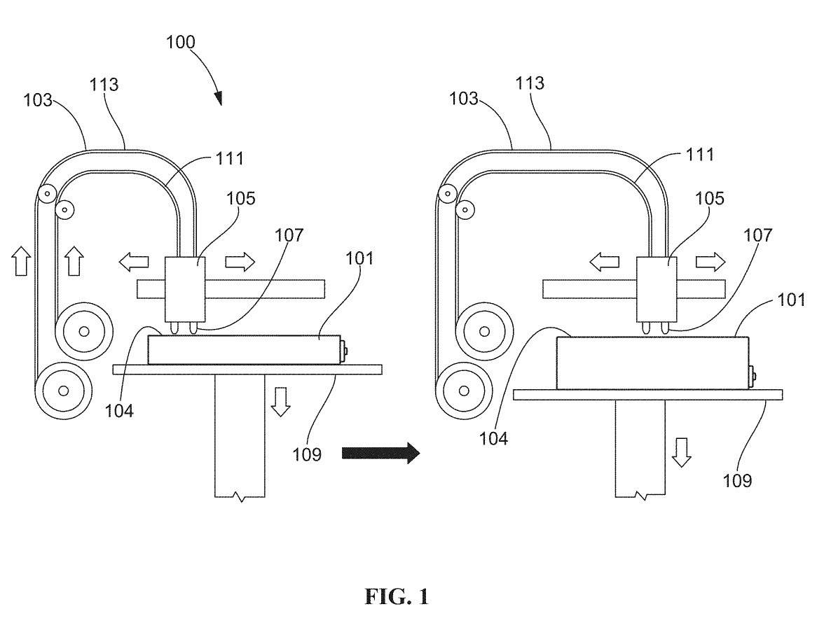

Referring to FIG. 1, in one embodiment, a method 100 of forming a composite article 101 includes any suitable additive manufacturing technique. One suitable additive manufacturing technique includes a filament and/or extrusion based process, such as, but not limited to, fused filament fabrication (FFF), fused deposition modeling (FDM), melted extrusion modeling, or a combination thereof. For example, the FDM process, an example of which is illustrated in FIG. 1, includes providing a build material 103, feeding the build material 103 to a printing head 105, heating the build material 103, extruding a heated build material 104 through a nozzle 107 in the printing head 105, and depositing the heated build material 104 directly or indirectly onto a base or platform 109 to form the composite article 101.

The build material 103 is provided to the printing head 105 in any suitable form, including, but not limited to, a filament 113, a sheet, pellets, a powder, a paste, or a combination thereof. After passing through the printing head 105, the extruded material 104 is deposited in a predetermined or predesigned pattern corresponding to a desired shape of the article 101, with multiple layers being deposited and joined to form the shape of the article 101. Each layer has a thickness of at least 5 microns, at least 10 microns, at least 20 microns, at least 50 microns, at least 100 microns, between 5 and 100 microns, between 10 and 50 microns, between 10 and 20 microns, or any combination, sub-combination, range, or sub-range thereof. In certain embodiments, a support material 111 is co-deposited with the extruded material 104 to support the extruded material 104 on the platform 109.

During the extrusion of the extruded material 104, the printing head 105 and/or the platform 109 are moved relative to each other, the relative movement depositing the extruded material 104 in the predetermined pattern. For example, in one embodiment, the platform 109 is stationary and the printing head 105 moves vertically and laterally to provide the 3D movement. In another embodiment, the printing head 105 is moved laterally, in a first plane, and the platform 109 is moved vertically, in a second plane perpendicular to the first. Additionally or alternatively, the platform 109 may include a multi-axis platform configured to provide three-dimensional movement corresponding to the predetermined pattern. In a further embodiment, the printing head 105 and/or the platform 109 may be rotated in addition to moving vertically and laterally to provide four-dimensional (4D) movement. Together, the lateral movement, vertical movement, and/or rotation of the printing head 105 and/or the platform 109 form the three-dimensional geometry of the composite article 101.

According to one or more of the embodiments disclosed herein, the movement of the printing head 105 and/or the platform 109 is controlled by computer software. The desired shape of the composite article 101 is modeled prior to manufacturing with a computer-aided design (CAD) software. This model is then communicated to a controller and read by controller software that directs the movement of the printing head 105 and/or platform 109 to form the desired article 101 based upon the CAD model.

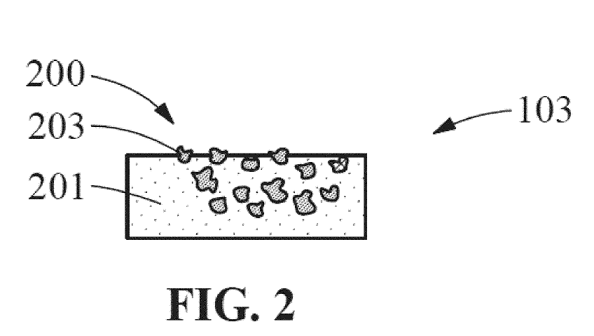

Turning to FIG. 2, in one embodiment, the build material 103 includes a composite formulation 200. In another embodiment, the composite formulation 200 includes a polymer and/or resin matrix 201 having one or more additives 203 blended and/or distributed therein at any suitable concentration. Suitable concentrations of the one or more additives 203 include, by volume, between about 10% and about 50%, between about 15% and about 50%, between about 20% and about 50%, between about 20% and about 40%, between about 30% and about 50%, between about 35% and about 45%, or any combination, sub-combination, range, or sub-range thereof.

The matrix 201 includes any suitable material for use in the additive manufacturing technique, such as, but not limited to, acrylonitrile butadiene styrene (ABS) and/or polyamide (PA) (e.g., PA6, PA6,6, PA10,10, and/or PA12). Other suitable materials for the matrix 201 include, but are not limited to, polyethylene (e.g., high, medium, low, and/or linear low density polyethylene, such as, metallocene-catalyzed polyethylene (m-LLDPE)); poly(ethylene-co-vinyl acetate) (EVA); polypropylene (PP); polyvinylidene fluoride (PVDF); copolymers of vinylidene fluoride (VDF) and hexafluoropropylene (HFP); terpolymers of vinylidene fluoride (VDF), HFP and/or tetrafluoroethylene (TFE), fluorinated ethylene propylene, ethylene tetrafluoroethylene, polytetrafluoroethylene, other suitable fluorinated matrices, or a combination thereof; polylactic acid (PLA); polyurethane (PU) and/or thermoplastic polyurethane (TPU); polyetherimide (PEI); polyether sulfone (PES); polycarbonate (PC); polybutylene terephthalate (PBT); polyethylene terephthalate (PET); liquid crystalline polymer (LCP); any other suitable thermoplastic and/or thermoplastic elastomer; or a combination thereof.

The material of the matrix 201 at least partially determines the properties of the composite formulation 200, including, but not limited to, thermal properties, electrical properties, mechanical properties, and/or processing properties. Additionally or alternatively, the one or more additives 203 may be included in the composite formulation 200 to provide and/or adjust one or more of the properties. For example, in one embodiment, the additives 203 decrease resistivity and/or increase conductivity in the composite formulation 200. In another embodiment, the additives 203 include any material with a molecular structure having a molar percentage of carbon that is equal to or less than 90%, and exclude any material with a molecular structure having a molar percentage of carbon that is greater than 90%. In a further embodiment, the additives 203 include metals, metalloids, semimetals, and/or ceramics, such as, but not limited to, copper (Cu), tin (Sn), aluminum (Al), nitrides, carbides, or any other filler that decreases resistivity and/or increases conductivity in the composite formulation 200, as compared to the matrix 201 alone, or a combination thereof. As used herein, and unless otherwise specified, the terms “conductivity” and “resistivity” refer to both electrical and thermal conductivity and resistivity.

The one or more properties provided and/or adjusted by the one or more additives 203 are dependent upon the type of filler, concentration of the filler, the material of the matrix 101, or a combination thereof. For example, in one embodiment, the additives 203 in the composite formulation 200 include ceramics, such as boron nitride, aluminum nitride, silicon nitride, beryllium nitride, alumina, silica, aluminum/calcium/magnesium silicates, silicon carbide, and/or a combination thereof, which form a thermally, but not electrically, conductive material. In another embodiment, the additives 203 include metallic fillers, which may be used to form materials with both thermal and electrical conductivity. In a further embodiment, the ceramics may be combined with graphite/carbon and/or metallic fillers to form materials with both thermal and electrical conductivity.

According to one or more of the embodiments disclosed herein, the increased electrical conductivity includes, but is not limited to, a resistivity in the composite formulation 200 of 0.1 ohm-cm or less, 10⁻² ohm-cm or less, 10⁻³ ohm-cm or less, 10⁻⁴ ohm-cm or less, between 0.1 ohm-cm and 10⁻⁵ ohm-cm, between 10⁻² ohm-cm and 10⁻⁵ ohm-cm, between 10⁻³ ohm-cm and 10⁻⁴ ohm-cm, or any combination, sub-combination, range, or sub-range thereof. Additionally or alternatively, the composite formulation 200 may include a thermal conductivity of at least 0.5 W/mK, at least 0.8 W/mK, at least 1.0 W/mK, at least 2.0 W/mK, at least 5 W/mK, at least 10 W/mK, between 0.5 W/mK and 5 W/mK, between 0.5 W/mK and 10 W/mK, or any combination, sub-combination, range, or sub-range thereof.

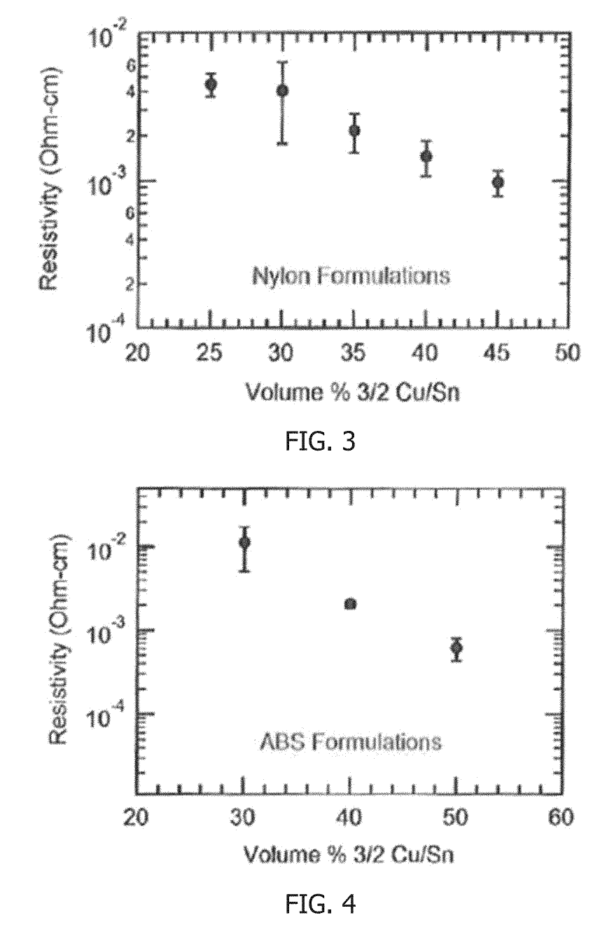

Referring to FIGS. 3-5, in one embodiment, the one or more additives 203 include a combination of copper and tin fillers distributed in the matrix 201. In another embodiment, the copper and tin fillers increase both thermal and electrical conductivity in the composite formulation 200, as compared to the matrix 201 alone. For example, in a further embodiment, as illustrated in FIGS. 3-4, a 3/2 ratio of the copper/tin fillers, at a concentration of between 20% and 50%, by volume, provides resistivities of between 10⁻² ohm-cm and 10⁻⁵ ohm-cm in thermoplastic polymers such as, but not limited to, nylon 6,6 (FIG. 3) and ABS (FIG. 4). While the resistivity of both composite formulations 200 decreases as the concentration of the copper/tin fillers increases, the initial resistivity and/or the amount of the decrease in resistivity differs between the thermoplastic materials, with the nylon 6,6 (FIG. 3) having a lower initial resistivity and smaller incremental decrease as compared to the ABS (FIG. 4). Additionally, although shown as a 3/2 copper/tin ratio in the examples above, as will be appreciated by those skilled in the art, the copper/tin fillers are not so limited and may include any other ratio between 1/2 and 4/1, preferably between 1/1 and 2/1, which may provide different thermal, electrical, mechanical, and/or processing properties of the composite formulation 200.

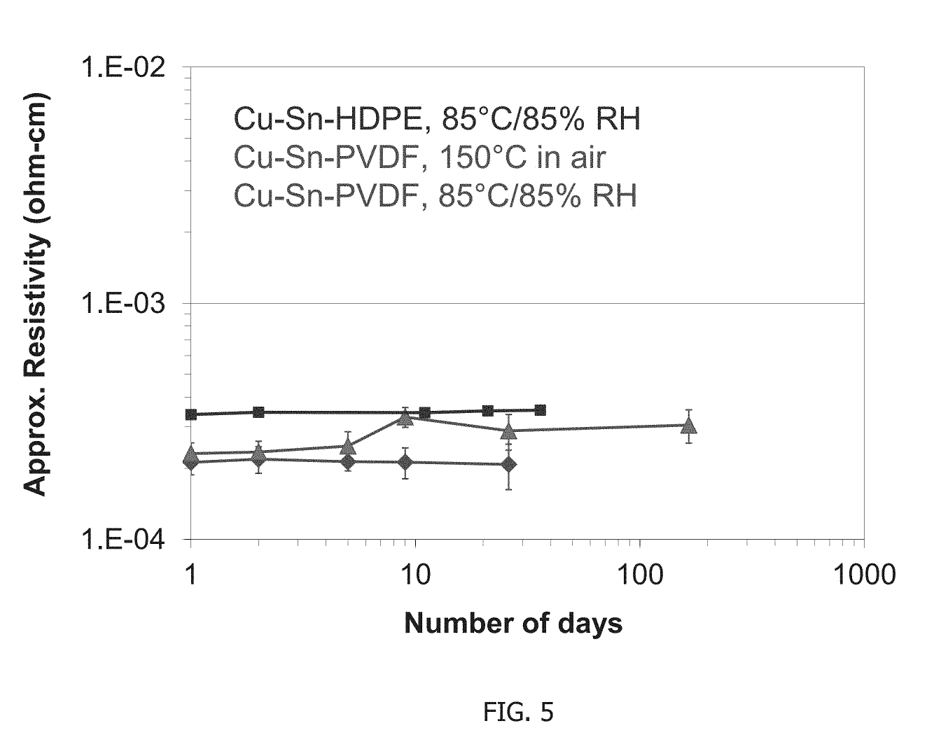

In certain embodiments, during processing and/or additional treatment, the composite formulation 200 forms an intermetallic layer that protects the copper/tin filler from oxidation. The low resistivity of the copper/tin fillers and the intermetallic layer formed during processing and/or additional treatment provides an improved combination of high conductivity and good stability to thermal aging and reflow, which increases electrical performance as compared to polymeric composites with existing fillers, such as carbon black. For example, as illustrated in FIG. 5, a conductive composite containing copper/tin filler has good electrical stability even after aging for more than 26 days at 150° C. in air, or 85° C. at 85% relative humidity.

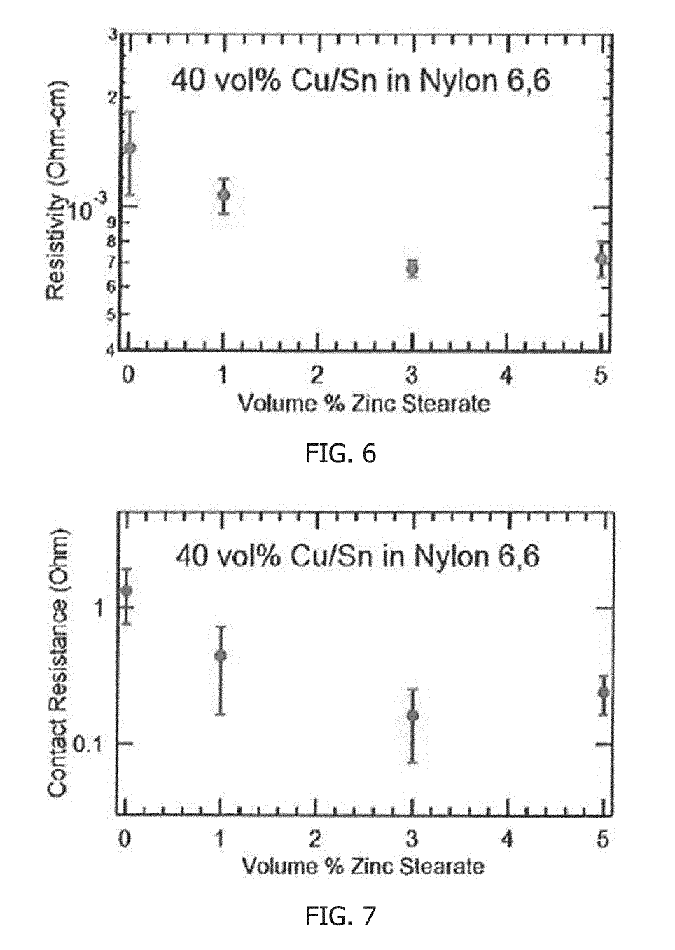

Additionally or alternatively, the composite formulation 200 may include one or more other additives 203, such as, but not limited to, plasticizers, process aids, dispersants, other metallic fillers, metal salts, ceramics, graphite, carbon fibers, or a combination thereof. For example, in one embodiment, the composite formulation 200 includes the fillers and any suitable amount of a stearate, such as between 1% and 10% zinc stearate, by volume. Other suitable stearates include, but are not limited to, magnesium stearate, calcium stearate, sodium stearate, and/or stearic acid. The zinc stearate further reduces the resistivity and contact resistance of the composite formulation 200, as compared to the polymer and filler alone. As shown in FIGS. 6-7, adding 3% zinc stearate, by volume, to a nylon 6,6 composite including 40% copper/tin, by volume, reduces the resistivity of the composite from between 1-2×10⁻³ ohm-cm to between 6-7×10⁻⁴ ohm-cm, and reduces the contact resistance from an order of 1Ω to an order of 0.1Ω.

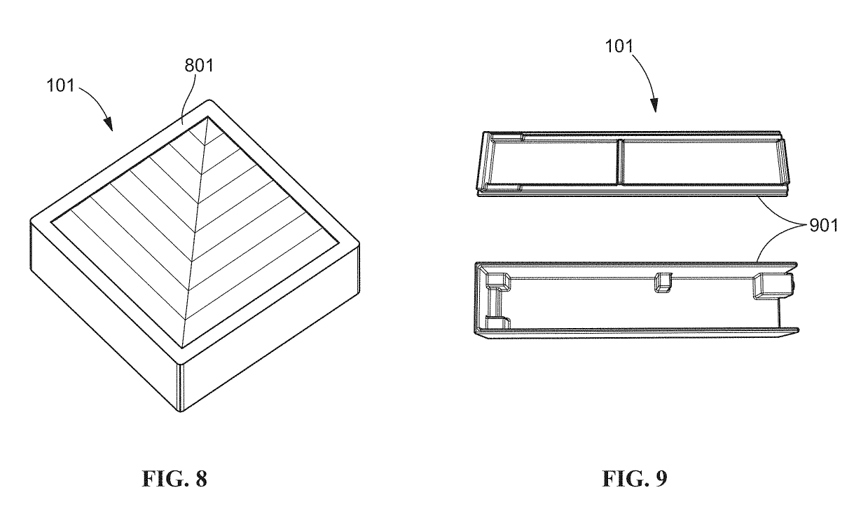

When formed according to one or more of the embodiments disclosed herein, the composite article 101 includes and/or exhibits the properties of the composite formulation 200. The composite article 101 may also include an additive manufacturing structure and/or microstructure formed during additive manufacturing of the composite formulation 200. Referring to FIG. 8, in one example, the composite article 101 includes an electrically conductive composite article 801 formed through additive manufacturing of the composite formulation 200 including copper/tin fillers in an ABS and/or nylon resin. Referring to FIG. 9, in another example, the composite article 101 includes a thermally conductive composite article 901 formed through additive manufacturing of the composite formulation 200 including boron nitride fillers in Nylon 12.

In one embodiment, the ABS and/or nylon, when loaded with the one or more additives 203, provide flow properties suitable for formation of the filament 113 and/or use in the additive manufacturing technique. In another embodiment, the ABS and/or nylon resin provides increased compatibility with the copper/tin fillers, as compared to other matrix materials. In a further embodiment, the ABS and/or nylon resin provides better adhesion during additive manufacturing, due to the higher surface energy compared to other, lower surface energy resins such as PVDF, and so the ABS and/or nylon resin may be preferred for additive manufacturing processes. The flow properties, increased compatibility between the ABS and/or nylon resin and the copper/tin fillers, and/or the increased adhesion may facilitate extrusion, injection molding, and/or other processing of the composite formulation 200 at temperatures above the melting temperature of tin (232° C.), without separation of the fillers and the resin.

Additionally, during processing and/or treatment, such as thermal annealing, the composite formulation 200 including the copper/tin fillers in ABS and/or nylon forms an intermetallic layer. The intermetallic layer decreases oxidation of the filler and/or increases stability to thermal aging and reflow, as compared to other composite materials. Together, the increased electrical conductivity provided by the copper/tin fillers and the decreased oxidation provided by the intermetallic layer provide an improved combination of high conductivity and good stability, as compared to other composite materials.

In certain embodiments, the method 100 of forming the composite article 101 includes treating the composite formulation 200 during and/or after the additive manufacturing. For example, in one embodiment, the method 100 includes thermal annealing of the composite article 101 at temperatures above the glass transition temperature of the matrix 201 and below the melting temperature of the matrix 201. In another embodiment, the thermal annealing is performed in air, inert gas atmosphere, or under vacuum, and may be performed with or without external pressure, such as that from a melt press.

The thermal annealing of the composite article 101 decreases the resistivity of the composite article. In one embodiment, the thermal annealing decreases the resistivity of additive manufactured articles, such that the resistivity of the article after thermal annealing approaches and/or equals the resistivity of the bulk composite formulation prior to forming the article. For example, in another embodiment, a 3 cm long part was additively manufactured using a composite formulation including 30%, by volume, copper/tin fillers in a nylon 6 resin, then annealed under vacuum at a temperature of between 200 and 220° C. The thermal annealing decreased the resistivity from 2-6×10⁻² ohm-cm to 2-8×10⁻³ ohm-cm, which approached the 2×10⁻³ ohm-cm resistivity of the bulk composite formulation. Additionally or alternatively, the thermal annealing may increase and/or restore the conductivity of an additively manufactured part including mechanical deformation(s) that negatively impact conductive properties. Additionally or alternatively, the thermal annealing may remove directional conductivity (i.e. anisotropic conductivity) such that the conductivity is approximately the same in all directions (i.e. isotropic conductivity).

Thermal annealing may also be performed during the additive manufacturing of the composite article 101. The thermal annealing during the additive manufacturing includes heating the composite article 101 and/or the area around the composite article 101 as it is being formed. Any suitable heating device may be used to heat the composite article 101 during the additive manufacturing, including, but not limited to, an IR lamp, a 150-375 watt light bulb, a heat gun, or a combination thereof. For example, in one embodiment, the platform 109 is heated to between 70° C. and 130° C., and the composite formulation 200 is extruded from a MakerBot FDM-type printer at a temperature of between 230° C. and 250° C. In another embodiment, the IR lamps, light bulbs, and/or heat guns heat the sample/build area where the composite article 101 is being formed. The heating devices are configured to increase the temperature, providing increased conductivity from the increased temperature without melting the composite formulation 200 and/or deforming the article 101. As will be appreciated by those skilled in the art, the desired increased temperature may differ for each resin matrix used in the composite formulation 200.

In another example, the composite formulation 200 including nylon 6 with copper/tin fillers is extruded at a temperature of 250° C. to a platform 109 at a temperature of 130° C., providing a temperature gradient of between 130° C. and 180° C. in the composite article 101. When the heating devices are used, the temperature of the composite article 101 is increased to a gradient of between 160° C. and 190° C. The increase in temperature increases the conductivity of the composite article 101 without deforming the article 101. Although described herein with regard to heating the composite article 101 and the area surrounding the composite article 101 during formation, the disclosure is not so limited and may include heating only the composite article 101 during additive manufacturing, such as, for example, by using tubing, air knives, spreaders, and/or reducers to focus the hot air from a heat gun directly onto the article 101. Without wishing to be bound by theory, it is believed that thermal annealing during the additive manufacturing process may increase adhesion between deposited layers, which increases the conductivity of the composite article 101 without post-annealing treatment.

Other suitable treatments during and/or after the additive manufacturing include, but are not limited to, ultrasonic welding, microwave treatment, laser treatment, focused infra-red (IR) heating, or a combination thereof. For example, in one embodiment, the method 100 includes heating the formed composite article 101 through ultrasonic welding, microwave, laser, and/or focus IR. In another embodiment, a weld, laser, and/or IR focused beam is incorporated into the additive manufacturing process, such as through attachment to the print nozzle 107. In a further embodiment, when incorporated into the additive manufacturing process, the weld, laser, and/or IR focused beam may be arranged and disposed to provide localized heating of the composite material 200 as it is deposited during the formation of the composite article 101. Additionally or alternatively, the method 100 may include plasma treatment, corona discharge, and/or any other treatment for individual additive layers to provide desired properties such as increased hydrophilicity, increased adhesion, or a combination thereof.

As compared to other manufacturing techniques, the additive manufacturing of the electrically and/or thermally conductive composite formulation facilitates rapid prototyping and testing, increased manufacturing efficiency, decreased manufacturing cost, economical manufacturing of a small number of parts, increased customization of articles, increased geometric and/or functional complexity, or a combination thereof.

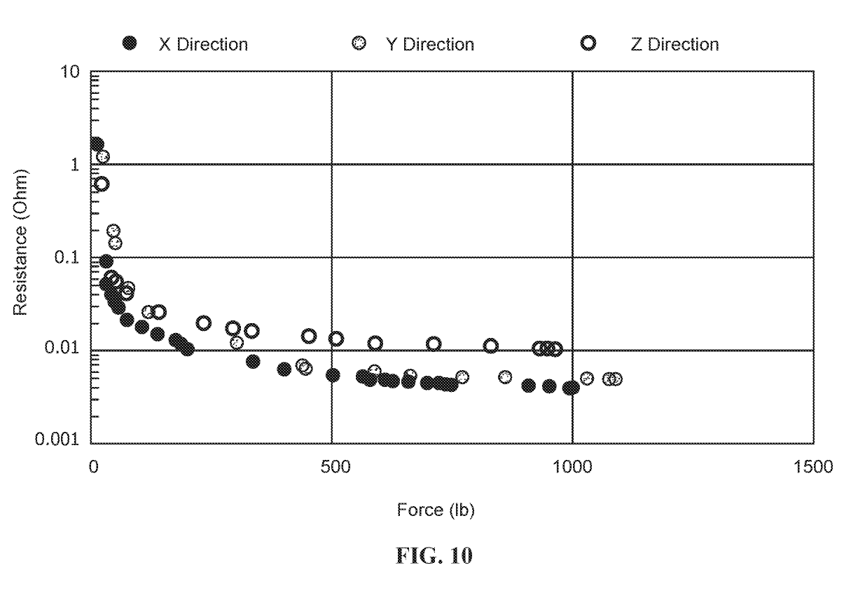

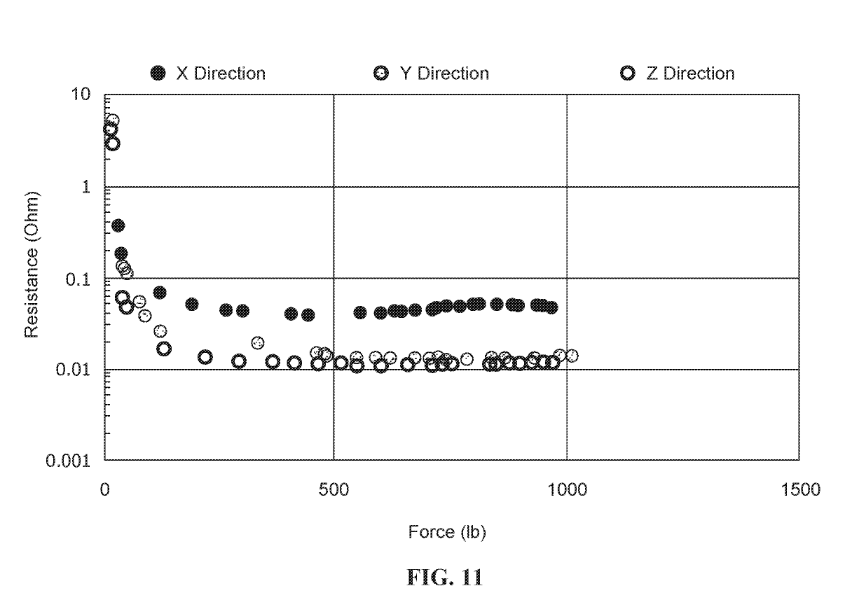

Turning to FIGS. 10-11, in one embodiment, the method 100 includes forming anisotropic conductive properties in the composite article 101, including, but not limited to, directional thermal and/or electrical conductivity. In another embodiment, forming the anisotropic conductive properties includes directionally printing the individual layers during the additive manufacturing process. For example, printing the composite article 101 in the Y direction provides increased resistance in the Z direction (as shown in FIG. 10). Without wishing to be bound by theory, it is believed that without external heat input each layer partially cools prior to the printing of a subsequent layer, the partial cooling decreasing adhesion between layers in the Z direction, for example, when printed in the Y direction. The decreased adhesion in the Z decreases conductivity in that direction, as compared to conductivity in other directions having comparatively increased adhesion. As will be appreciated by those skilled in the art, printing in directions other than the Y direction will decrease adhesion in directions other than the Z direction, and as such, the print direction may be varied to provide anisotropic properties in a desired direction within the composite article 101.

Another method for forming the anisotropic conductive properties includes forming gaps in the composite article 101 during additive manufacturing. For example, in one embodiment, vertical gaps are embedded in the composite article 101 during additive manufacturing, the vertical gaps decreasing conductivity in the orthogonal direction. In another example, the composite formulation 200 was extruded through a 0.53 mm nozzle to form strands having a diameter of 0.53 mm, with each strand being printed 0.8 mm apart. Printing the 0.53 mm diameter strands 0.8 mm apart, as opposed to the standard distance of 0.1 mm greater than the nozzle size (i.e., 0.63 mm), decreases or eliminates contact between strands in the X direction, when the strands are printed in the Y direction. As illustrated in FIG. 11, the resulting resistivity in the X direction is much higher than that of the Y and Z directions. As will be appreciated by those skilled in the art, the spacing is not limited to 0.8 mm, and may be varied based upon desired conductivity and/or the nozzle size being used. Suitable nozzle sizes include, but are not limited to, between 0.4 mm and 0.53 mm, with larger nozzle sizes decreasing nozzle clogging and/or reducing printing resolution in some embodiments.

Other methods for forming anisotropic conductive properties include, but are not limited to, adjusting process parameters during the additive manufacturing. The process parameters include, but are not limited to, nozzle temperature, build area temperature, build plate temperature, build speed, resolution and/or distance between printed layers, or a combination thereof. The adjusting of the process parameters during the additive manufacturing increases or decreases a degree of anisotropy formed in the composite article 101.

For example, in one embodiment, decreasing an extrusion and/or build speed increases cooling of each layer between deposition of subsequent layers, which decreases conductivity in the vertical direction, as compared to the orthogonal directions, and increases the anisotropy of the composite article 101. For example, decreasing a build speed in the Y direction from 90 mm/sec to 15 mm/sec decreases conductivity in the Z direction, as compared to conductivity in the X and/or Y direction. In another embodiment, decreasing the build area and/or the build plate temperature increases cooling of the article, which increases anisotropy of the composite article 101. For example, in contrast to the expected decrease in Z direction conductivity, decreasing the build plate temperature from 110° C. to 50° C. during additive manufacturing of a copper/tin/nylon composite increased resistivity in the X and Y direction by about 4 times, while the resistivity in the Z direction was unaffected. In another embodiment, decreasing a distance between layers increases contact between layers, which increases conductivity in the vertical direction. In another embodiment, eliminating the standard bottom layers and/or reducing the 2 outer layers to a single outer layer increases anisotropy in the composite article 101 formed therefrom. In a further embodiment, the composite article 101 is printed with both conductive and nonconductive material, the conductive material forming anisotropic channels within the composite article 101. Additionally or alternatively, the anisotropic thermal and/or electrical conductivity in the composite article 101 may be adjusted and/or tuned by increasing conductivity through thermal annealing and/or other hybrid or post-processing techniques.

Adjusting the process parameters during the additive manufacturing may also adjust other properties of the composite article 101 formed therefrom. For example, decreasing the print speed and/or increasing the layer height increases the conductivity of the article 101. Suitable print speeds include, but are not limited to, between 5 mm/sec and 150 mm/sec, between 10 mm/sec and 100 mm/sec, between 15 mm/sec and 90 mm/sec, or any combination, sub-combination, range, or sub-range thereof. Suitable layer heights include any height that provides a desired resolution of the article, up to the diameter of the nozzle being used, with an increased number of layers in a given part reducing the conductivity of the part. In another embodiment, decreasing a distance between layers increases contact between layers, which increases conductivity. In another example, increasing nozzle size, increasing travel speed, and/or stopping or reducing the cooling fan speed decreases nozzle clogging, which increases article consistency and/or conductivity. Suitable travel speeds include, but are not limited to, at least 50 mm/sec, between 100 mm/sec and 300 mm/sec, between 150 mm/sec and 250 mm/sec, or any combination, sub-combination, range, or sub-range thereof. In another example, increasing retraction, such as from 1 mm at 30 mm/sec to 1.75 mm at 20 mm/sec, reduces drool.

Exemplary embodiments are further described and illustrated with respect to the following examples which are presented by way of explanation, not limitation.

### EXAMPLES

### Example 1

In one example, an electrically conductive composite formulation was formed from a nylon 6 matrix including 30% copper/tin fillers. The composite formulation was extruded into 1.7 mm filament and then provided to a MakerBot FDM-type 3D printer. A 12×12×12 mm composite article was then additively manufactured from the composite formulation at an extruder temperature of 235° C., a build plate temperature of 130° C., a print speed of 90 mm/sec, a layer height of 0.2 mm being extruded from a 0.53 mm diameter nozzle, a travel speed of 250 mm/sec, and a retraction of 1.75 mm at 20 mm/sec. The composite article formed through the additive manufacturing process described above exhibited an electrical conductivity of 5×10⁻³ ohm-cm, which is only slightly higher than the bulk resistivity of the material from which it was printed, which is 2×10⁻³ ohm-cm.

### Example 2

In another example, a thermally conductive composite formulation was formed from a polymer matrix including boron nitride filler. The composite formulation was extruded into 1.7 mm filament and provided to an FDM-type 3D printer. A 2 inch thermally conductive composite article with a nearly-isotropic thermal conductivity of 5.6 W/m-K was then additively manufactured from the composite formulation, using the print parameters described in example 1 above.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A method of forming a composite article, the method comprising:
providing a composite formulation, the composite formulation including a polymer matrix and at least one additive distributed in the polymer matrix at a concentration of between 10% and 50%, by volume;
feeding the composite formulation to a printing head of an additive manufacturing device;
heating the composite formulation to form a heated composite formulation;
extruding the heated composite formulation through a nozzle in the printing head; and
depositing the heated composite formulation onto a platform to form the composite article;
wherein the depositing of the heated composite formulation to form the composite article includes forming an additive manufacturing structure within the composite article; and
wherein the at least one additive has a molar percentage of carbon that is equal to or less than 90%.

2. The method of claim 1, wherein the at least one additive comprises a filler selected from the group consisting of a metal, a metalloid, a semimetal, a ceramic, and combinations thereof.

3. The method of claim 2, wherein the filler comprises copper and tin.

4. The method of claim 1, wherein the composite formulation is electrically conductive, having a resistivity of between 10⁻² ohm-cm and 10⁻⁵ ohm-cm.

5. The method of claim 3, wherein the at least one additive further comprises, by volume, between 1% and 10% zinc stearate.

6. The method of claim 5, wherein the composite formulation is electrically conductive, having a resistivity less than 10⁻³ ohm-cm.

7. The method of claim 1, wherein the polymer matrix and the at least one additive are configured to eliminate separation of the at least one additive from the polymer matrix during the forming of the composite article.

8. The method of claim 1, wherein the polymer matrix is a thermoplastic.

9. The method of claim 8, wherein the polymer matrix is selected from the group consisting of acrylonitrile butadiene styrene (ABS), nylon, and a combination thereof.

10. The method of claim 1, wherein the depositing of the heated composite formulation onto the platform comprises moving at least one of the printing head and the platform.

11. The method of claim 10, further comprising:
generating a model of the composite article with computer-aided design software;
communicating the model to a controller;
reading the model with controller software; and
directing the moving with the controller based upon the reading of the model by the controller software.

12. The method of claim 1, further comprising treating the composite article to decrease a resistivity thereof.

13. The method of claim 12, wherein the treating comprises thermal annealing during the depositing.

14. The method of claim 12, wherein the treating results in isotropic conductivity.

15. A method of forming a composite article, the method comprising:
providing a composite formulation, the composite formulation including a thermoplastic and at least one additive distributed in the thermoplastic at a concentration of between 10% and 50%, by volume, the at least one additive comprising a filler selected from the group consisting of a metal, a metalloid, a semimetal, a ceramic, and combinations thereof;
feeding the composite formulation to a printing head of an additive manufacturing device;
heating the composite formulation to form a heated composite formulation;
extruding the heated composite formulation through a nozzle in the printing head; and
depositing the heated composite formulation onto a platform to form the composite article;
wherein the depositing of the heated composite formulation to form the composite article includes forming an additive manufacturing structure within the composite article;
wherein the at least one additive has a molar percentage of carbon that is equal to or less than 90%; and
wherein the composite article has anisotropic conductivity.

16. A composite article produced from a composite formulation, the composite formulation having at least one additive distributed in a polymer matrix, the composite article comprising:
the polymer matrix; and
the at least one additive, the at least one additive including a filler at a concentration of between 10% and 50%, by volume;
wherein the filler has a molar percentage of carbon that is equal to or less than 90% and comprises at least one of a metal, a metalloid, a semimetal, a ceramic;
wherein the composite article has an additive manufacturing structure; and
wherein the composite article has an electrical resistivity that of 1×10⁻² to 1×10⁻⁵ ohm-cm.

17. The composite article of claim 16, wherein the filler is selected from the group consisting of copper, tin, tungsten carbide, and combinations thereof.

18. The composite article of claim 16, wherein the composite article includes anisotropic conductivity.

19. The composite article of claim 18, wherein the composite article is electrically conductive.
